(19) United States
(12) Patent Application Publication
(10) Pub. No.: US 2006/0280098 A1
(43) Pub. Date: Dec. 14, 2006

(54) Diffraction element and optical disk device

(76) Inventor: Hiroshi Sakai, Nagano (JP)

Correspondence Address: CANTOR COLBURN, LLP, 55 GRIFFIN ROAD SOUTH, BLOOMFIELD, CT, 06002, US

(21) Appl. No.: 11/440,889

(22) Filed: May 25, 2006

(30) Foreign Application Priority Data
May 25, 2005 (JP) 2005-152912

(51) Int. Cl. G11B 7/00

(52) U.S. Cl. 369/112.01

(57) ABSTRACT

A diffraction element may include a grating region where a plurality of groove parts and a plurality of protruded parts are alternately formed on a surface of the diffraction element and flat regions where the surface of the diffraction element is formed to be a flat face. The flat regions are formed on both sides of the grating region and are formed at a height of “nλ” from the center position in the depth direction of the groove part; wherein “λ” is the wavelength of an incident light beam to the diffraction element and “n” is an integer number. The diffraction element may be disposed at a midway position in the forward path as a three-beam generating element.

### CROSS REFERENCE TO RELATED APPLICATION

The present invention claims priority under 35 U.S.C. §119 to Japanese Application No. 2005-152912 filed May 25, 2005, which is incorporated herein by reference.

### Field of the Invention

An embodiment of the present invention may relate to a diffraction element in which a groove part and a protruded part are alternately arranged, and may relate to a device for use with an optical disk device provided with the diffraction element.

### BACKGROUND OF THE INVENTION

Various structures have been proposed to detect a signal from an optical disk. Even when various structures are utilized, an optical disk device commonly includes a laser light source, a photo-detector, and an optical system that structures a forward path for guiding a laser beam emitted from the laser light source to an optical disk and a return path for guiding a return light beam reflected by the optical disk to the photo-detector. Further, various diffraction elements are used for the optical disk device.

For example, the following technique has been disclosed. In order to obtain a tracking error signal by a DPP (Differential Push-Pull) method or the like, a main beam comprised of a 0-order (zero-order) light beam and sub-beams comprised of diffracted light beams are generated from a light beam emitted from a laser light source by a diffraction element. A diffraction element is used as an above-mentioned diffraction element in which groove parts are formed in an area smaller than the cross sectional area of a light beam and the offset of tracking is canceled by using a diffracted light beam and a light beam which is not diffracted (see, for example, Japanese Patent Laid-Open No. Hei 10-162383)

However, in the case of the diffraction element which is described in the above-mentioned prior art, a large difference in the phase of the main beam occurs between an area provided with groove parts and a flat portion which is not provided with the groove parts, and thus the occurrence of aberration is not prevented.

### BRIEF DESCRIPTION OF THE INVENTION

In view of the problems described above, an embodiment of the present invention may advantageously provide a diffraction element which is capable of canceling the offset of tracking by using a diffracted light beam and a light beam which is not diffracted and which is capable of preventing the generation of an astigmatism, and which provides a device for use with an optical disk in which the diffraction element is used.

Thus, according to an embodiment of the present invention, there may be provided a diffraction element including a grating region where a plurality of groove parts and a plurality of protruded parts are alternately formed on the surface of the diffraction element, and also flat regions are formed where the surface of the diffraction element is formed to be a flat face. The flat region is formed at the height of “nλ” from a center position in the depth direction of the groove part (wherein “λ” is the wavelength of an incident light beam to the diffraction element and “n” is an integer number) and the flat regions are formed on both sides of the grating region in the longitudinal direction of the groove part.

The diffraction element to which the present invention is applied can be used in a device for use with an optical disk. The device may include a laser light source, a photo-detector, an optical system which structures a forward path for guiding a laser beam emitted from the laser light source to the optical disk and a return path for guiding a return light beam reflected by the optical disk to a photo-detector, and a diffraction element which is disposed in the forward path or the return path of the optical system between the laser light source and the optical disk. Further, the cross sectional area of the light beam emitted from the laser light source on the diffraction element is set to be larger than the grating region.

In accordance with an embodiment, the center position in the depth direction of the groove part is set to be the same height position in the longitudinal direction of the groove part. According to the structure described above, the generation of astigmatism due to the diffraction element can be prevented.

In accordance with an embodiment, respective center positions in the depth direction of a plurality of groove parts are set to be the same height position. According to the structure described above, the generation of astigmatism due to the diffraction element can be prevented. Therefore, it is preferable that the center position in the depth direction of the groove part is set to be the same height position in the longitudinal direction of the groove part and the respective center positions in the depth direction of a plurality of the groove parts are set to be the same height position. In this case, the flat region may be formed at the same height position as the center position in the depth direction of the groove part.

In accordance with an embodiment, stepped portions formed as boundaries between the grating region and the flat regions formed on both sides of the grating region are formed in parallel. According to the structure described above, the diffraction element may be disposed such that the grating region formed in the direction perpendicular to the longitudinal direction of the groove part is extended to the outside of the cross sectional area of the light beam on the diffraction element. Therefore, when the diffraction element is to be mounted on an optical disk device, adjustment in the direction perpendicular to the longitudinal direction of the groove part can be roughly performed and workability of mounting work can be improved.

Thus, the diffraction element may include a grating region where a plurality of groove parts and a plurality of protruded parts are alternately formed on the surface of the diffraction element, and flat regions where the surface of the diffraction element is formed to be a flat face and which are formed on both sides of the grating region in the longitudinal direction of the groove part. Further, the flat region is formed at a height of “nλ” from the center position in the depth direction of the groove part (wherein “λ” is the wavelength of an incident light beam to the diffraction element and “n” is an integer number). Therefore, for example, when the diffraction element to which the present invention is applied is used in the optical system of an optical disk device, and when the diffraction element is disposed to be used as a three-beam generating element such that the grating region is located over a region which is smaller than the cross sectional area of a light beam, the offset of tracking can be canceled by using a diffracted light beam and a light beam which is not diffracted, and generation of astigmatism in the diffraction element can be prevented.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is an explanatory view showing the schematic structure of an optical disk device in accordance with a first embodiment of the present invention.

FIG. 2(a) is a plan view showing a diffraction element which is used in the first embodiment, FIG. 2(b) is a sectional view showing the diffraction element that is shown cut along the longitudinal direction of a groove part, and FIG. 2(c) is its perspective view.

FIGS. 3(a), 3(b), 3(c), 3(d) and 3(e) are explanatory views showing variations of the light intensity distribution of 0-order light beam before and after the transmission of the diffraction element which is used in the first embodiment.

FIG. 4(a) is an explanatory view showing a state where spots are formed on an optical recording disk in an optical disk device to which the present invention is applied. FIG. 4(b) is an explanatory view showing a state that spots are formed on an optical recording disk in a conventional optical disk device.

FIG. 5(a) is a plan view showing a diffraction element which is used in a second embodiment of the present invention, and FIG. 5(b) is a sectional view showing the diffraction element that is cut along the longitudinal direction of a groove part.

FIG. 6(a) is a plan view showing a diffraction element which is used in a third embodiment of the present invention, and FIG. 6(b) is a sectional view showing the diffraction element that is shown cut along the longitudinal direction of a groove part.

### DETAILED DESCRIPTION OF THE PREFERRED EMBODIMENTS

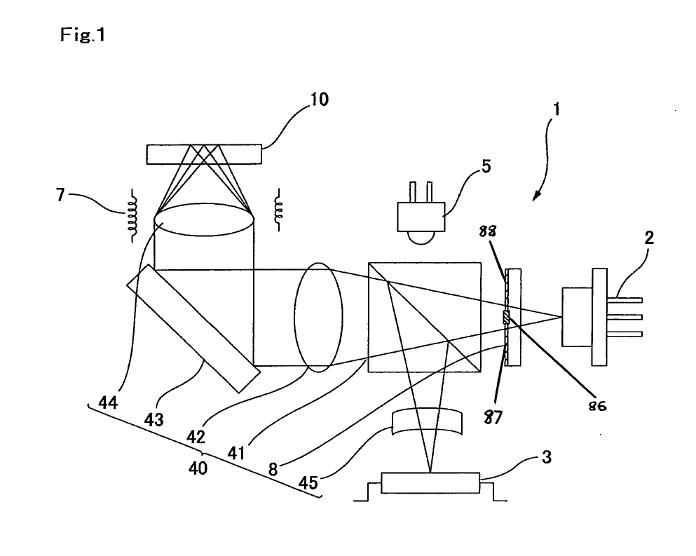

FIG. 1 is an explanatory view showing a schematic structure of an optical disk device in accordance with a first embodiment of the present invention.

In FIG. 1, an optical disk device I in accordance with the first embodiment includes a semiconductor laser 2 for emitting a laser light beam with, for example, the wavelength of 650 nm and a photo-detector 3. Further, the optical disk device I is provided with an optical system 40 including a beam splitter 41, a collimating lens 42, a rising mirror 43 and an objective lens 44 from the semiconductor laser 2 to an optical recording disk 10. A forward path through which the laser beam emitted from the semiconductor laser 2 is guided to the optical disk 10 is structured by these optical elements. Further, the optical system 40 is provided with a sensor lens 45 between the beam splitter 41 and the photo-detector 3. A return path through which the return light beam reflected by the optical disk 10 is guided to the photo-detector 3 is structured by the objective lens 44, the rising mirror 43, the collimating lens 42, the beam splitter 41 and the sensor lens 45. A front monitor 5 (photo-detector for monitor) for detecting a light beam reflected by the beam splitter 41 among the light beam which is directed to the optical disk 10 from the semiconductor laser 2 is disposed on the rear side of the beam splitter 41 with respect to the photo-detector 3.

The photo-detector 3 is used to generate a focusing error signal and a tracking error signal when information is recorded or reproduced by detecting the return light beam reflected by the optical recording disk 10. The focusing error signal and the tracking error signal is fed back to an objective lens drive device 7.

The optical recording disk 10 is, for example, a DVD-RAM (Digital Versatile Disk Random Access Memory). In a DVD-RAM, lands and grooves with wobble (undulation) are alternately formed in a concentric manner (not shown) and both the lands and the grooves are used as a track in which a pit is formed. A signal obtained from the wobble is used for pull-in of a clock.

In the optical disk device 1 in accordance with the first embodiment, a diffraction element 8 comprised of a grating or a hologram element is disposed between the semiconductor laser 2 and the beam splitter 41 for generating a sub-beam comprised of −1st-order diffracted light beam, a main beam comprised of 0-order light beam, and a sub-beam comprised of +1st-order diffracted light beam from the laser beam emitted from the semiconductor laser 2. Therefore, reproduction of information can be performed by the main beam comprised of 0-order light beam which is converged on a track of the optical disk 10 through the objective lens 44 and the return light beam which is detected by the photo-detector 3. Further, recording of information can be performed by the main beam comprised of 0-order light beam which is converged on a track of the optical recording disk 10 through the objective lens 44. In addition, a sub-beam comprised of −1st-order diffracted light beam and a sub-beam comprised of +1st-order diffracted light beam are converged through the objective lens 44 at positions interposing the spot of the main beam in the tangential direction of the track of the optical disk 10. A tracking error signal can be obtained by detecting the return light beam with the photo-detector 3 and by utilizing a Differential Push Pull (DDP) method or the like.

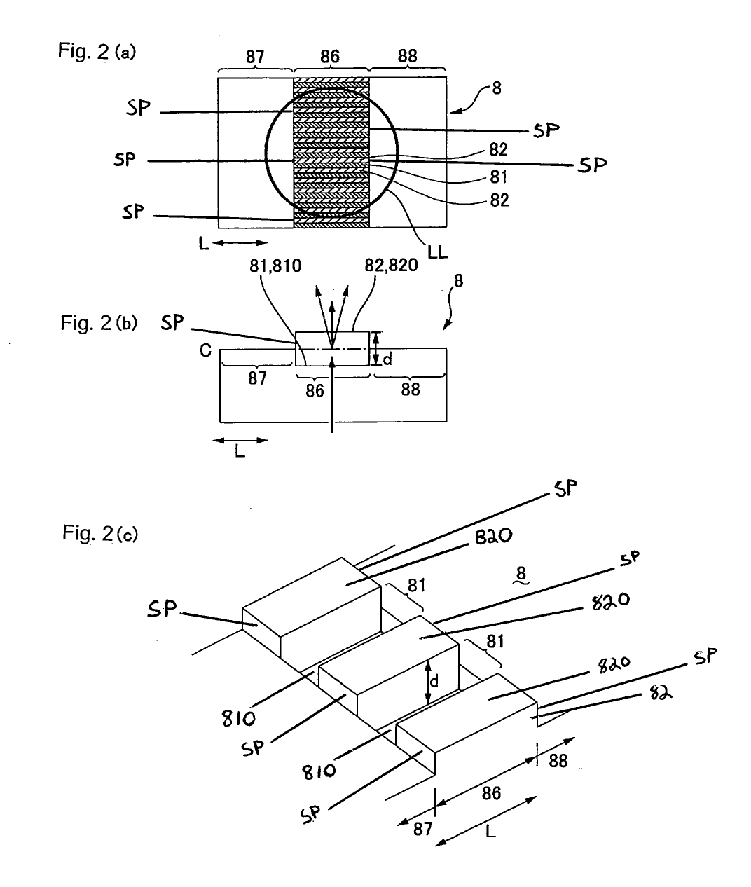

FIG. 2(a) is a plan view showing a diffraction element which is used in the first embodiment, FIG. 2(b) is a sectional view showing the diffraction element which is shown cut along the longitudinal direction of a groove part, and FIG. 2(c) is its perspective view.

As shown in FIGS. 2(a), 2(b) and 2(c), in the diffraction element 8 which is used in the optical disk device 1 in accordance with the first embodiment, a grating region 86 where a plurality of groove parts 81 and a plurality of protruded parts 82 are alternately arranged is formed on the center portion 86 of the diffraction element 8. Flat regions 87, 88 whose faces are formed to be flat faces are formed on both sides of the grating region 86.

In accordance with an embodiment, all groove parts 81 are formed such that each depth dimension “d” between the bottom part 810 of the groove part 81 and the upper faces 820 of protruded parts 82 on both sides of the groove part 81 is formed to be the same depth in the longitudinal direction (shown by the arrow “L) of the groove part 81. Further, the depths of a plurality of the groove parts 81 are respectively set to be the same depth (See FIGS. 2(b) and 2(c). Therefore, the center position (shown by the alternate long and short dash line “C” in FIG. 2(b)) in the depth direction of the groove part 81 is set to be the same height position in the longitudinal direction of the groove part 81 and, in addition, set to be the same height position in the adjacent groove parts 81. In this embodiment, the flat regions 87, 88 are formed to be the same height as the center position in the depth direction of the groove part 81. The flat regions (87, 88) are formed at the height of “nλ” from a center position C in the depth direction of the groove part (wherein “λ” is the wavelength of an incident light beam to the diffraction element and “n” is an integer number) and the flat regions (87, 88) are formed on both sides of the grating region 86 in the longitudinal direction “L” of the groove part 86.

Thus, the diffraction element in accordance with the present invention may include a grating region 86 where a plurality of groove parts 81 and a plurality of protruded parts 82 are alternately formed on the surface of the diffraction element 8, and flat regions (87, 88) are formed where the surface of the diffraction element is formed to be a flat face and which are formed on both sides of the grating region 86 in the longitudinal direction of the groove part. Further, the flat regions (87, 88) are formed at a height of “nλ” from the center position C in the depth direction of the groove part (wherein “λ” is the wavelength of an incident light beam to the diffraction element and “n” is an integer number). Therefore, for example, when the diffraction element 8 to which the present invention is applied is used in the optical system for use with an optical disk device, and when the diffraction element is disposed to be used as a three-beam generating element such that the grating region 86 is located over a region which is smaller than the cross sectional area of a light beam, the offset of tracking can be canceled by using a diffracted light beam and a light beam which is not diffracted, and generation of astigmatism in the diffraction element can be prevented.

In accordance with this embodiment, the width dimension of the groove part 81 and the width dimension of the protruded part 82 in the diffraction element 8 are the same as each other and all the duty ratio of the grating is 50:50. Further, in this embodiment, stepped portions SP are formed as boundaries between the grating region 86 and the flat regions 87, 88 formed on both sides of the grating region 86 are formed in parallel as shown in FIG. 2(a).

In the diffraction element 8 structured as described above, the grating region 86 is formed in a striped shape (see stripe-like repeating sections 82, 81, 82, 81, 82 in FIG. 2(a) ) in the direction parallel to the longitudinal direction “L” of the groove part 81 (see FIG. 2a) and the laser beam emitted from the semiconductor laser 2 is incident on the diffraction element 8 so as to extend over the grating region 86 and the flat regions 87, 88. In accordance with an embodiment, the far field pattern of the laser beam emitted from the semiconductor laser 2 is elliptical. Its major axis direction corresponds to a direction perpendicular to the longitudinal direction of the groove part 81 and its minor axis direction corresponds to the longitudinal direction of the groove part 81. Further, the region of the laser beam emitted from the semiconductor laser 2 which is shown by the circle “LL” in FIG. 2(a) is utilized for being converged on the optical recording disk 10.

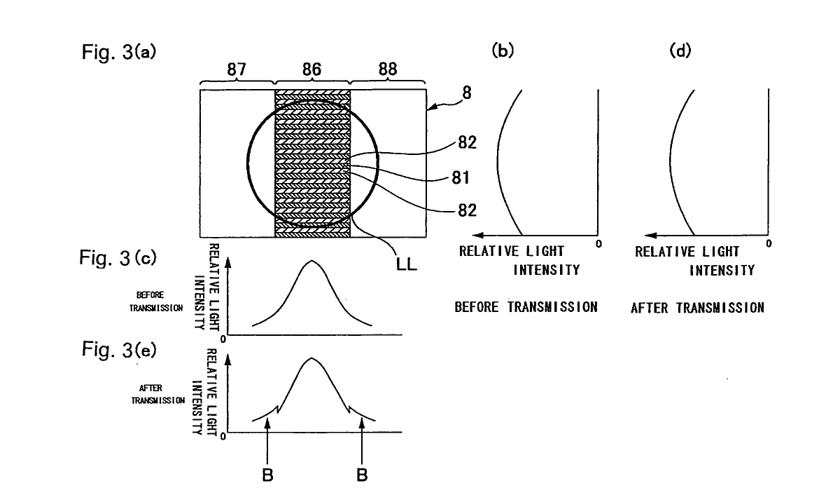

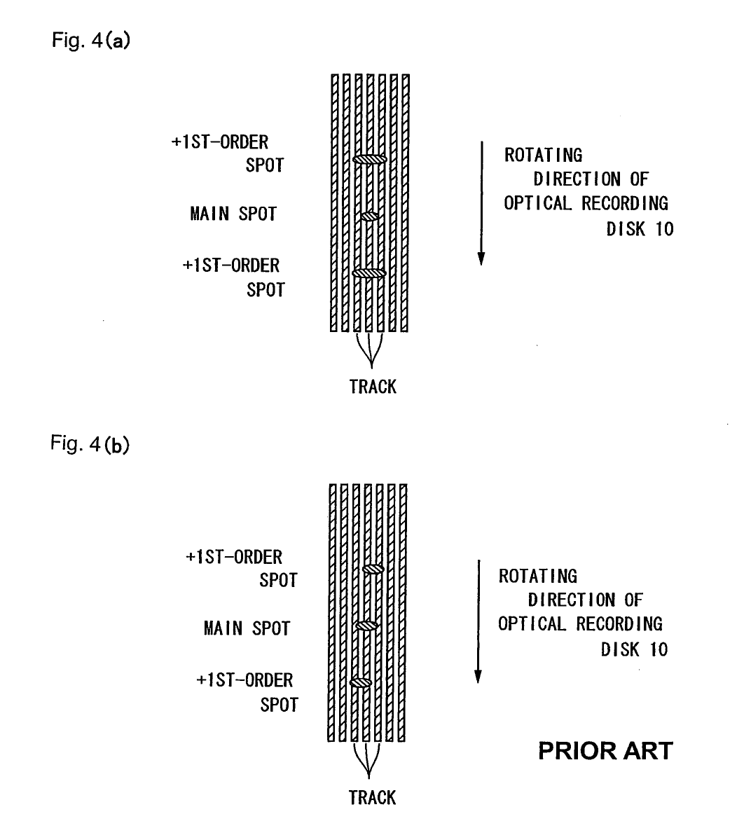

FIGS. 3(a), 3(b), 3(c), 3(d) and 3(e) are explanatory views showing variations of a light intensity distribution of 0-order light beam before and after the transmission of the diffraction element which is used in the first embodiment. FIG. 3(a) is a plan view of the diffraction element 8. The light intensity distributions of the incident light to the diffraction element 8 are shown in FIGS. 3(b) and 3(c) so as to correspond to the directions to the diffraction element 8 shown in FIG. 3(a). The light intensity distributions of the emitted light beam from the diffraction element 8 are shown in FIGS. 3(d) and 3(e) so as to the directions to the diffraction element 8 shown in FIG. 3(a). FIG. 4(a) is an explanatory view showing a state where spots are formed on an optical disk in an optical disk device to which the present invention is applied. FIG. 4(b) is an explanatory view showing a state that spots are formed on an optical disk in a conventional optical disk device.

As shown in FIGS. 3(a), 3(b) and 3(d), in the optical disk device 1 in accordance with the first embodiment, the light quantity distribution of the laser light beam when the diffraction element 8 is shown cut in a direction perpendicular to the groove part 81 of the diffraction element 8 does not indicate a large variation between before and after the transmission through the diffraction element 8. However, as shown in FIGS. 3(a), 3(c) and 3(e), the light quantity distribution of the laser light beam when the diffraction element 8 is cut in a direction parallel to the groove part 81 of the diffraction element 8 indicates a large variation before and after the transmission through the diffraction element 8. In other words, in this diffraction element 8, the ±1st-order diffraction efficiencies in the grating region 86 in the longitudinal direction of the groove part 81 are high but the ±1st-order diffraction efficiencies in both the flat regions 87, 88 are zero. Therefore, the optical intensity of the zero-order light beam emitted through the grating region 86 decreases largely but the optical intensity of the zero-order light beam emitted through both the side regions 87, 88 does not decrease. Accordingly, the peak shape of the zero-order light beam becomes to be the shape in which, although the light quantity decreases largely in the grating region, the level of the lower slope portion is raised as shown by the arrow “B” in FIG. 3(e). As a result, the zero-order light beam which is incident on the objective lens 44 is capable of obtaining a similar effect as if “NA” (Numerical Aperture) is increased.

FIG. 4(a) shows an example in accordance with the first embodiment when the main beam is converged on the optical disk 10 and FIG. 4(b) shows a conventional example. According to the first embodiment, the spot diameter of the main spot which is converged on the optical disk 10 can be made smaller. Therefore, even when the power of the laser beam emitted from the semiconductor laser 2 is small, recording to the optical disk 10 can be performed, and thus power saving and cost reduction can be attained and measures for heat generation can be easily performed.

Further, in the first embodiment, all the duty ratio of the grating in the diffraction element 8 may be set to be 50:50 and thus the generation of high-order diffraction light beams can be restrained. Therefore, when sub-beams are converged on the optical disk 10, both the spot diameters of +1st-order sub-spot and −1st-order sub-spot are enlarged in comparison with the conventional example (see FIGS. 4(a) and 4(b). Accordingly, since the tolerance of positional accuracy between a track and the sub-beams becomes wider, when the optical disk device 1 is manufactured, working efficiency can be improved. Moreover, even when an optical disk 10 with a different track pitch is used, a tracking error signal can be appropriately obtained.

In addition, even when the diffraction element 8 is used as a three-beam generating element by arranging the diffraction element 8 such that the grating region 86 and the flat regions 87, 88 are located within a region which is smaller than the cross sectional area of a light beam as described in this embodiment, the flat regions 87, 88 are formed at the same height as the center position in the depth direction of the groove part 81. Therefore, the generation of astigmatism in the diffraction element 8 can be surely prevented and the diffraction element 8 can be made thinner.

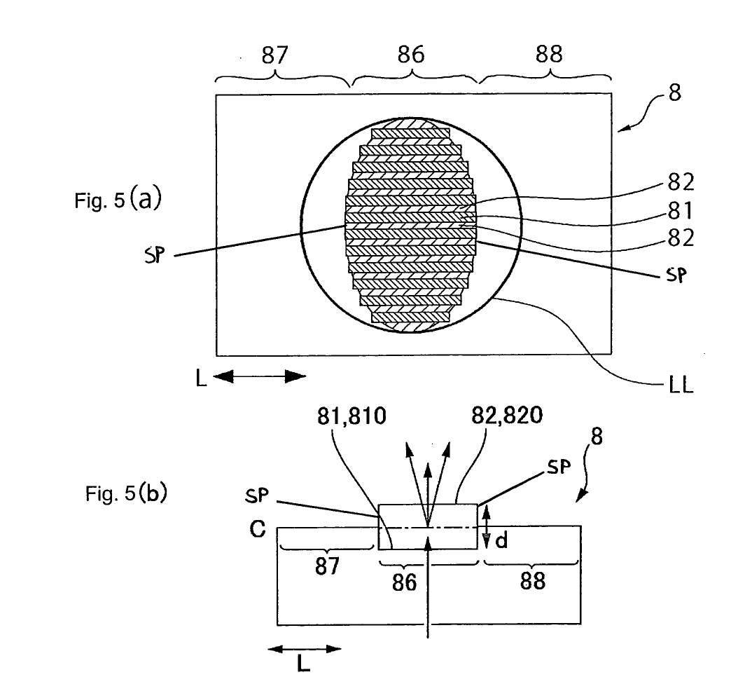

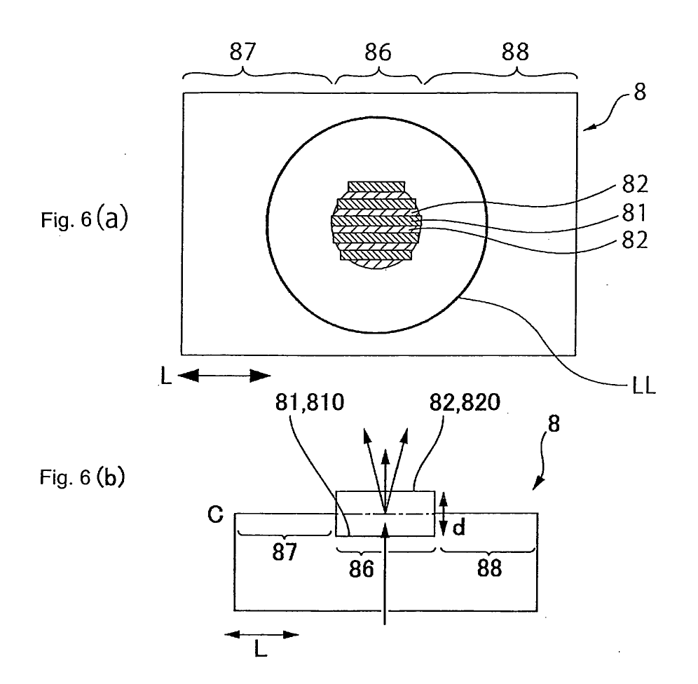

FIG. 5(a) is a plan view showing a diffraction element which is used in a second embodiment of the present invention and FIG. 5(b) is a sectional view showing the diffraction element which is cut (a sectional view) along the longitudinal direction of a groove part. FIG. 6(a) is a plan view showing a diffraction element which is used in a third embodiment of the present invention, and FIG. 6(b) is a sectional view showing the diffraction element which is cut along the longitudinal direction of a groove part. The basic structure of the second and third embodiments described below is common to the first embodiment and thus the same notational symbols are used in the common portions.

As shown in FIGS. 5(a), 5(b) and FIGS. 6(a), 6(b), also in an optical disk device 1 in accordance with the second and third embodiments, similarly to the first embodiment, a grating region 86 where a plurality of groove parts and a plurality of protruded parts are alternately arranged is formed at the center portion of the diffraction element 8. Further, flat regions 87, 88 whose face is formed to be a flat face are formed on both sides of the grating region 86.

The groove parts 81 in the second and third embodiments are respectively formed such that the depth dimension “d” between the upper faces 820 of the protruded parts 82 on the both sides of the groove part 81 and the bottom part 810 of the groove part 81 is formed to be the same depth in the longitudinal direction of the groove part 81 (shown by the arrow “L”). Further, the depths of adjacent groove parts 81 are formed to be the same depth as each other. Therefore, the center position (shown by the alternate long and short dash line “C” in FIG. 5(b)) in the depth direction of the groove part 81 is set to be the same height position in the longitudinal direction of the groove part 81 and, in addition, set to be the same height position in the adjacent groove parts 81. Also in the second and third embodiments, the flat regions 87, 88 are formed to be the same height as the center position in the depth direction of the groove part 81.

In addition, in the grating region of the diffraction element 8, the width dimension of the groove part 81 and the width dimension of the protruded part 82 are equal to each other and thus all the duty ratio of the grating is 50:50. However, in the diffraction element 8 of the second embodiment, stepped portions SP are formed as a boundary between the grating region 86 and the flat regions 87, 88 are formed in an elliptical shape as shown in FIG. 5(a). In the diffraction element 8 of the third embodiment, stepped portions SP as a boundary between the grating region 86 and the flat regions 87, 88 are formed in a circular shape as shown in FIG. 6(a).

In addition, in the first, the second and the third embodiments described above, the flat regions 87, 88 are formed to be the same height as the center position in the depth direction of the groove part 81. In other words, the flat regions 87, 88 are formed to be the height which corresponds to the case of “n=0” when the height of the flat regions 87, 88 from the center position in the depth direction of the groove part 81 is set to be (nλ). However, the flat regions 87, 88 may also be formed at a height that is different from the center position in the depth direction of the groove part 81. In other words, the flat regions 87, 88 may be formed at a height position which is lower or higher by the integral number of times of the wavelength (λ) of the incident light beam from the center position in the depth direction of the groove part 81.

Also, in accordance with an embodiment, stepped portions formed as boundaries between the grating region and the flat regions may be formed on both sides of the grating region and are formed in parallel. According to the structure described above, the diffraction element may be disposed such that the grating region formed in the direction perpendicular to the longitudinal direction of the groove part is extended to the outside of the cross sectional area of the light beam on the diffraction element. Therefore, when the diffraction element is to be mounted on an optical disk device, adjustment in the direction perpendicular to the longitudinal direction of the groove part can be roughly performed and workability of mounting work can be improved.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A diffraction element comprising:
a grating region where a plurality of groove parts and a plurality of protruded parts are alternately formed on a surface of the diffraction element; and
flat regions where a surface of the diffraction element is formed to be a flat face;
wherein the flat regions are formed at a height of “nλ” from a center position in a depth direction of the groove part wherein “λ” is a wavelength of an incident light beam to the diffraction element and “n” is an integer number and wherein the flat regions are formed on both sides of the grating region in a longitudinal direction of the groove part.

2. The diffraction element according to claim 1, wherein the center position in the depth direction of the groove part is set to be the same height position in the longitudinal direction of the groove part.

3. The diffraction element according to claim 1, wherein the center positions in the depth direction of the groove parts are respectively set to be the same height position.

4. The diffraction element according to claim 1, wherein
the center position in the depth direction of the groove part is set to be the same height position in the longitudinal direction of the groove part, and
the center positions of the groove parts are respectively set to be the same height position, and
the flat region is formed at the same height position as the center position in the depth direction of the groove part.

5. The diffraction element according to claim 1, wherein stepped portions formed as boundaries between the grating region and the flat regions formed on both sides of the grating region are formed in parallel.

6. A device for use with an optical disk comprising:
a laser light source;
a photo-detector;
an optical system which structures a forward path for guiding a laser beam emitted from the laser light source to the optical disk and a return path for guiding a return light beam reflected by the optical disk to the photo-detector; and
a diffraction element which is disposed between the laser light source and the optical disk in the forward path or the return path of the optical system,
the diffraction element comprising;
a grating region where a plurality of groove parts and a plurality of protruded parts are alternately formed on a surface of the diffraction element; and
flat regions where a surface of the diffraction element is formed to be a flat face;
wherein the flat region is formed at a height of “nλ” from a center position in a depth direction of the groove part wherein “λ” is a wavelength of an incident light beam to the diffraction element and “n” is an integer number and
the flat regions are formed on both sides of the grating region in a longitudinal direction of the groove part, and
wherein a cross sectional area of the light beam emitted from the laser light source on the diffraction element is set to be larger than the grating region of the diffraction element.

7. The optical disk device according to claim 6, wherein the diffraction element is disposed at a midway position in the forward path as a three-beam generating element which forms a main beam comprised of a zero-order light beam and two sub-beams comprised of diffracted light beams from the laser beam emitted from the laser light source.
